(19) United States
(12) Patent Application Publication
(10) Pub. No.: US 2025/0224179 A1
(43) Pub. Date: Jul. 10, 2025

(54) HALF PIPE HEAT EXCHANGE SYSTEM FOR ELECTRIC ARC, METALLURGICAL OR REFINING FURNACES AND SYSTEM THEREOF

(71) Applicant: AMERIFAB, INC., Indianapolis (IN)

(72) Inventor: Richard J. Manasek, Carmel, IN (US)

(21) Appl. No.: 19/013,204

(22) Filed: Jan. 8, 2025

Related U.S. Application Data
(60) Provisional application No. 63/618,608, filed on Jan. 8, 2024.

(51) Int. Cl. F27D 1/12; F27D 9/00

(52) U.S. Cl. CPC F27D 1/12; F27D 2009/0018; F27D 2009/0067

(57) ABSTRACT

A cooling assembly for cooling exhaust gases emitted from a steel-making furnace includes a body having a cross-sectional shape with a thickness defined between an outer surface and an inner surface thereof. The body includes a first mounting end having a first length and a second mounting end having a second length, the second length being different from the first length. The body is arcuately-shaped with a concave inner surface and convex outer surface, and the second mounting end is spaced from the first mounting end. A fluid conduit is defined between the inner surface and the surface for a cooling fluid to flow therethrough.

### RELATED APPLICATIONS

This application claim the benefit of U.S. Provisional Patent Application Ser. No. 63/618,608, filed Jan. 8, 2024, the disclosure of which is hereby incorporated by reference in its entirety.

### FIELD OF THE DISCLOSURE

The present disclosure relates generally to a method and apparatus for extending the operational life of electric arc furnaces, metallurgical furnaces, including metal smelting and refining furnaces. In particular, the disclosure relates to heat exchange systems used to protect such equipment.

### BACKGROUND

It is known to use cooling elements to protect equipment used in various steel industry processes. Such equipment may need to operate in extreme heat-flux conditions. Conventional cooling elements typically include mitered pieces to create a serpentine water flow. Such conventional mitered pieces have a sharp, angular nature that affect the flow of fluid in the cooling elements.

It is also desirable to be able to choose to fabricate the tubes and resulting elements from any suitable material and using any method of fabrication suitable for the material being used.

### SUMMARY

In one implementation of the present disclosure, a cooling assembly for cooling exhaust gases emitted from a steel-making furnace includes a body configured to be coupled to a surface of the furnace, the body including a cross-sectional shape having a thickness defined between an outer surface and an inner surface thereof, the body including a first mounting end having a first length and a second mounting end having a second length, the second length being different from the first length; wherein, the body is arcuately-shaped with a concave inner surface and convex outer surface; wherein, the second mounting end is spaced from the first mounting end; wherein, a fluid conduit is defined between the inner surface and the surface for a cooling fluid to flow therethrough.

In a first example of this implementation, the first mounting end and the second mounting end form a curvature. In a second example, the body forms a first face and a second face, the first face located at the first mounting end and the second face located at the second mounting end. In a third example, the first and second faces are parallel to one another. In a fourth example, the first face and the second face are disposed at an angle relative to a vertical plane passing through the first and second mounting ends.

In a fifth example, the first face is offset from the inner surface. In a sixth example, the second face is offset from the inner surface. In a seventh example, the inner surface forms a radial inner surface. In an eighth example, the first face forms a first outer portion that is configured to be in contact with the surface, the first outer portion being disposed at angle relative to a horizontal plane formed by the surface; the second face forms a second outer portion that is configured to be in contact with the surface, the second outer portion being disposed at angle relative to the horizontal plane.

In another example, the first face and the second face are located approximately 180° relative to one another about an axis passing through the inner surface. In yet another example, the first face and the second face are located less than 180° relative to one another about an axis passing through the inner surface. In a further example, the inner surface forms a first circumference and the outer surface forms a second circumference, the first circumference being less than the second circumference.

In another implementation of the present disclosure, a heat exchange system includes a furnace configured to heat an interior of the furnace and generate hot exhaust gases; a panel of sinuously winding piping having an inlet and an outlet, the piping forming a fluid passage through which a cooling fluid flows between the inlet and the outlet; the piping including a body configured to be coupled to a mounting surface of the furnace, the body including a cross-sectional shape having a thickness defined between an outer surface and an inner surface thereof, the body including a first mounting end having a first length and a second mounting end having a second length, the second length being different from the first length; wherein, the body is arcuately-shaped with a concave inner surface and convex outer surface; wherein, the second mounting end is spaced from the first mounting end.

In one example of this implementation, the body forms a first face and a second face, the first face located at the first mounting end and the second face located at the second mounting end. In a second example, the first face and the second face are disposed at an angle relative to a vertical plane passing through the first and second mounting ends. In a third example, the first face and the second face are offset from the inner surface. In a fourth example, the first face forms a first outer portion that is configured to be in contact with the surface, the first outer portion being disposed at angle relative to a horizontal plane formed by the surface; the second face forms a second outer portion that is configured to be in contact with the surface, the second outer portion being disposed at angle relative to the horizontal plane.

In another example, the first face and the second face are located approximately 180° relative to one another about an axis passing through the inner surface. In yet another example, the first face and the second face are located less than 180° relative to one another about an axis passing through the inner surface.

In a further implementation of the present disclosure, a cooling assembly for cooling exhaust gases emitted from a steel-making furnace includes a plate configured to be coupled to the furnace, the plate having a first surface and a second surface, the first surface opposite the second surface; a body coupled to the plate, the body including an inner surface, an outer surface, a first mounting end having a first length and extending from a first face to a second face, and a second mounting end having a second length and extending from the first face to the second face, the second length different from the first length; wherein the first mounting end is mounted to the first surface at a first angle greater than 0°; wherein the second mounting end is mounted to the first surface at a second angle greater than 0°, the first mounting end spaced from the second mounting end; wherein a fluid conduit is formed between the inner surface and the first surface.

### BRIEF DESCRIPTION OF THE DRAWINGS

FIG. 1 illustrates a schematic of a metallurgical furnace;

FIG. 2 illustrates a front perspective view of a first implementation of a half pipe return.

FIG. 3 illustrates a bottom perspective view of the half pipe return of FIG. 2;

FIG. 4 illustrates a front view of the half pipe return of FIG. 2;

FIG. 5 illustrates a cross-sectional view of the half pipe return taken along line A-A of FIG. 4;

FIG. 6 illustrates a front view of a second implementation of a half pipe return assembly;

FIG. 7 illustrates a top view of a half pipe return assembly;

FIG. 8 illustrates a front perspective view of a half pipe elbow;

FIG. 9 illustrates a bottom perspective view of the half pipe elbow of FIG. 8;

FIG. 10 illustrates a front view of the half pipe elbow of FIG. 8;

FIG. 11 illustrates a cross-sectional view of a half pipe elbow;

FIG. 12 illustrates a front view of a half pipe elbow assembly coupled to a plate;

FIG. 13 illustrates a top view of a half pipe elbow assembly;

### DETAILED DESCRIPTION

In an electric arc furnace (EAF), a portion above a hearth or smelting area must be protected against the high internal temperatures of the furnace. The EAF vessel wall, cover or roof and duct work are particularly at risk from massive thermal, chemical, and mechanical stresses caused by charging the steel. These stresses greatly limit the operational life of the furnace. The EAF is generally designed and fabricated as a welded steel structure which is protected against the high temperatures inside the furnace vessel by a refractory lining and water cooled panels. Water-cooled roof panels and water-cooled sidewall panels are located in portions of the furnace vessel above the melting/smelting area of the furnace.

In addition, furnace off-gas ducts also include a plurality of pipe around its circumference that protect the ductwork from the high temperatures and caustic gases produced during furnace operation. Existing water-cooled panels and ducts are made both with various grades and types of plates and pipes. Using water-cooled panels reduces refractory costs, enables steel makers to operate each furnace for a greater number of heats and enables the furnaces to operate at increased levels of power and chemical energy input. These panels are designed to incorporate a plurality of pipes in serpentine fashion and hung on the inside wall of the electric arc furnace above the hearth, thereby forming a cooling surface between the interior and the furnace wall. Existing water-cooled panels and ducts use mitered pieces to connect the plurality of pipes to configure this serpentine fashion.

It is important to maintain a layer of slag on the hot side of the water cooled panels to protect the panels from thermal and arcing degradation during normal furnace operation. Slag cups, slag bars, slag pins and specially designed extruded pipe with splines on the hot side surface of the pipe may be used to retain splattered slag on the hot side surface of the panels. Slag solidifies on the pipes, forming an insulation barrier between the molten iron material and the cooling pipes and, consequently, the wall of the furnace.

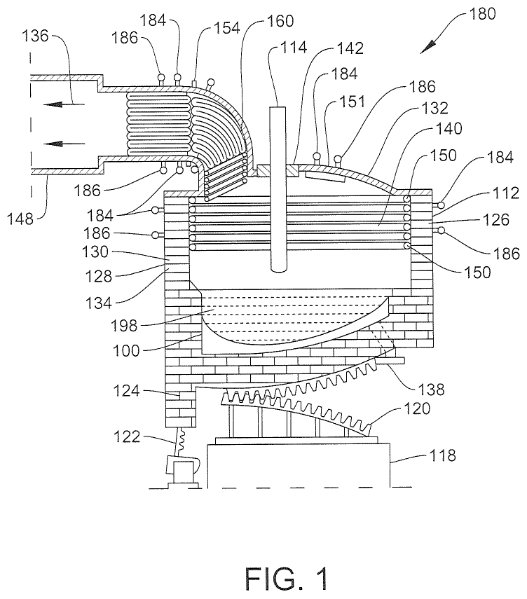

Referring to FIG. 1, one implementation of a furnace is illustrated as an EAF type furnace 180. While the EAF is disclosed as one example, it is understood the principles and teachings of the present disclosure may be readily applied in a basic oxygen furnace (BOF) and the like. In FIG. 1, an EAF 180 may include a furnace shell 112, a plurality of electrodes 114, an exhaust system, a working platform 118, a rocker tilting mechanism 120, a tilt cylinder 122, and an off gas chamber. The furnace shell 112 may be movably disposed upon the rocker tilt 120 or other tilting mechanism. Further, the rocker tilt 120 may be powered by the tilt cylinder 122. The rocker tilt 120 may also be further secured upon the working platform 118.

The furnace shell 112 may include a dished hearth 124, a generally cylindrical side wall 126, a spout 128, a spout door 130, and a general cylindrical circular roof 132. The spout 128 and spout door 130 are located on one side of the cylindrical side wall 126. In the open position, the spout 128 may allow intruding air 134 to enter the hearth 124 and partially burn gasses 136 produced from smelting. The hearth 124 is formed of a suitable refractory material. At one end of the hearth 124 is a pouring box having a tap means 138 at its lower end. During a melting operation, the tap means 138 is closed by a refractory plug, or a slidable gate. Thereafter, the furnace shell 112 is tilted, the tap means 138 is unplugged, or open and molten metal is poured into a teeming ladle, tundish, or other device, as desired.

The inside wall 126 of the furnace shell 112 may be fitted with water cooled panels 140 of sinuously winding piping 150. The panels, in effect serve as an interior wall in the furnace 180. The manifolds, which supply cool water and a return, are in fluid communication with the panels 140. Typically, the manifolds are positioned peripherally in a fashion similar to the illustrated exhaust ducts.

The heat exchanger system produces a more efficient operation and prolongs the operation life of the EAF furnace 180. In one illustrative implementation, the panels 140 may be assembled such that the sinuously winding piping has a generally horizontal orientation. The piping 150 can be linked with a linkage or have a base that is mounted to the wall. Alternatively, the panels 140 can be mounted such that the sinuously winding piping 150 has a generally vertical orientation. The upper ends of the panels 140 may define a circular rim at the upper margin of the side wall 126 portion of the furnace 180.

The heat exchanger system can be fitted to the roof 132 of the furnace 180, wherein the water cooled panels 140 have a curvature that substantially follows the domed contour of the roof 132. The heat exchanger system may be deployed on the inside of side wall 126 of the furnace 180, the roof 132 and the entrance of the exhaust system, as well as throughout the exhaust system. As such, the heat exchanger system can protect the furnace and cools the hot waste gasses 136 as they are ducted to a bag house or other filtering and air treatment facilities, where dust is collected and the gasses are vented to the atmosphere.

In operation, hot waste gasses 136, dust and fumes are removed from the hearth 124 through a vent in the furnace shell 112. The vent may be in communication with an exhaust system.

The panel 140 can have a plurality of axially arranged pipes 150. U-shaped returns can connect adjacent sectional lengths of piping or pipes 150 together to form a continuous piping system. Linkages and the like that additionally serve as spacers may be between adjacent pipes 150, and they provide structural integrity of the panel 140 and are determinative of curvature to the panel 140.

The heat exchange system or heat exchanger may include at least one panel of the sinuously winding piping 150 having an inlet (not shown) and an outlet (not shown), an input manifold in fluid communication with the inlet of the at least one panel, an output manifold in fluid communication with the outlet of the at least one panel, and a cooling fluid flowing through the piping 150. The heat exchanger system cools hot fume gasses 136 and dust that is being evacuated from the metallurgical furnace 180 and its supporting components. The piping is an assemblage of sectional lengths of connected tubes mounted side-by-side, wherein the connected tubes are secured to each other with the linkage, therein forming the at least one panel 140.

It has been determined that one illustrative and desirable composition for fabricating the piping 150 is of an aluminum bronze alloy. Aluminum bronze alloys have been found to have a higher than expected thermal conductivity, resistance to etching by the stream of hot gasses (modulus of elasticity), and good resistance to oxidation. Thus, the operational life of the heat exchanger is extended. Corrosion and erosion of the heat exchanger and related components is reduced when they are fabricated with aluminum bronze. Aluminum bronze has thermal conductivity that is 41% higher than P22 (about 96% Fe, 0.1% C, 0.45% Mn, 2.65% Cr, 0.93% Mo) and 30.4% than carbon steel (A106B). The heat exchangers fabricated using aluminum bronze and alloys thereof are more efficient, and have a longer operational life than furnace constructed of refractive materials and/or other metal alloys.

It has also been determined that the piping 150 may be extruded, and that extruding may help the piping resist corrosion, erosion, pressure, and thermal stress. The piping can be curved or bent to match the curvature of a wall to which it is being attached, if so needed. More typically, the individual sections of piping 150 may be secured to each other with an angled linkage such that the resulting panel has a curvature that is comparable or similar to the curvature of the wall of the furnace 180.

In the implementation of FIG. 1, the sinuously winding piping 150 may be formed by a plurality of longitudinal piping sections in which two of the piping sections are connected by a return pipe (referred to as a “return”) or an elbow pipe (referred to as an “elbow”).

Illustratively, high heat flux resistant, fluid-cooled elements having relatively high heat transfer rates and high water velocities according to the present disclosure are provided. It will be appreciated that the elements may have any suitable fluid such as a liquid including, for example, water running therethrough. The present disclosure provides a way to select a wider range of materials for manufacture of user selectively shaped and designed water-cooled elements for steel industry applications. As noted, liquids or coolants other than water also fall within the scope of the present disclosure. The elements will have the ability to better withstand the hostile and ever changing requirements in the furnaces, flue gas systems, off gas hoods, skirts, combustion chambers, drop out boxes, etc. due to the inherent and improved coolant velocity within the tube(s)/element(s) and the resulting increased heat transfer capability. The present disclosure allows for the selection of fabrication material and method of fabrication including, for example, by casting, stamping or forging, as desired, to the required or desired cross-sectional radius in order to optimize the heat transfer and elasticity requirements for the particular application and without limitation to current requirements to select the tube/pipe from materials that are available on the commercial market.

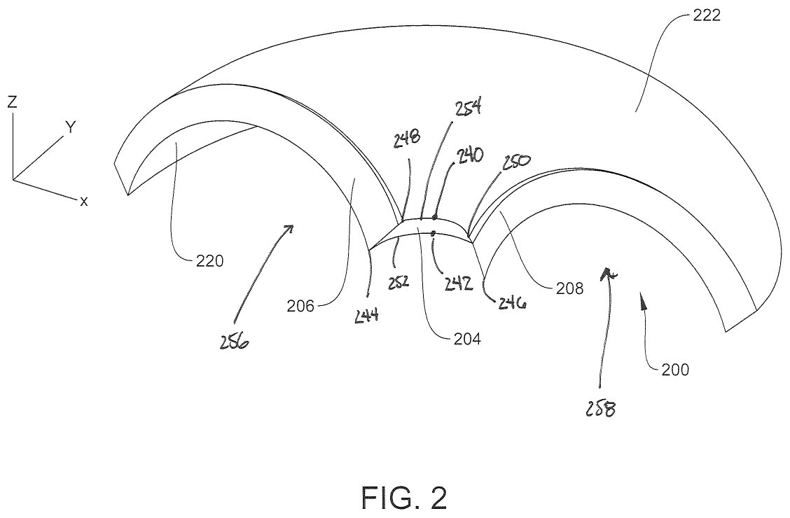

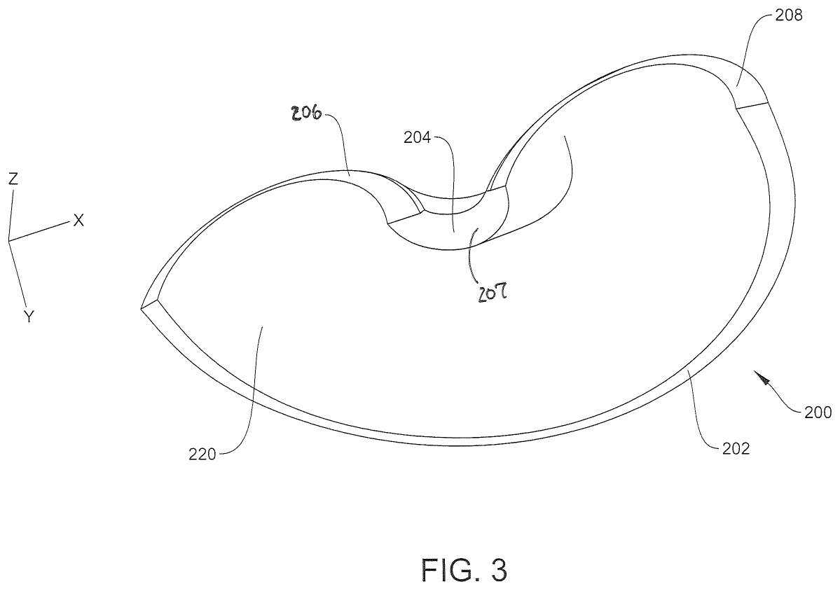

Referring to FIGS. 2 and 3, a cooling element or heat exchange apparatus in the form of a half pipe return 200 is formed into a desired shape such as, for example, a partially bent or angled half pipe. The illustrated half pipe return 200 has a body that extends from a first mounting end 202 to a second mounting end 204 to define an arcuate and generally concave inner surface 220 and an arcuate and generally convex outer surface 222 arcing respectively between the first mounting end 202 and the second mounting end 204. The first mounting end 202 may be radially spaced from the second mounting end 204. As fluid passes through the half pipe return 200, the first or second mounting end may form an inlet 256 and the other an outlet 258. The half pipe return 200 may have a first face 206 and a second face 208 formed between the first mounting end 202 and the second mounting end 204. The first face 206 is radially spaced apart from the second face 208. In one implementation, the first face 206 and second face 208 may each be disposed within a plane that is substantially parallel to one another. In other words, the half pipe return 200 represents a partially segmented, substantially hollow torus or donut shape in the form of a hollow ring torus formed in a first plane and a second plane. For example, the half pipe return 200 may take the form of a hollow ring torus divided or formed in an XY-plane and an XZ-plane. In other implementations, the first face 206 and second face 208 may each be disposed within a different plane that is angled relative to one another. In one example, the angular relationship between the planes may be less than 180°. In another example, the angular relationship between the planes may be 90° or less. Other angular relationships are possible in this disclosure.

The half pipe return 200 may form a third face 207 located at the second mounting end 204. In one implementation, the third face 207 may be disposed between the first face 206 and second face 208. In some implementations, the first face 206 may be disposed within a first plane and the second face 208 may be disposed within a second plane, and the third face 207 may be disposed within a third plane. In some implementations, the third plane is parallel to the first and second planes. In other implementations, the third plane is angular disposed relative to the first and second planes. For example, in FIG. 2, the first and second planes (and thus the first face 206 and second face 208) may be aligned along an X-Z plane. In some examples, the third plane (and thus the third face 207) may be angled about the X-axis such that the third face 207 is angled relative to the first face 206 and second face 208.

The orientation of the third face 207 is further shown in FIG. 2. As shown, the first face 207 may be located in contact with the second face 206 along a segment or portion defined between a first connecting portion 244 (e.g., first point) and a third connecting portion 248 (e.g., third point). The third face 207 may be located in contact with the second face 208 along a segment or portion defined between a second connecting portion 246 (e.g., second point) and a fourth connecting portion 250 (e.g., fourth point). The third face 207 may be in contact with the inner surface 220 along a first line segment 252 defined between the first connecting portion 244 and the second connecting portion 246. Likewise, the third face 207 may be in contact with the outer surface 222 along a second line segment 254 defined between the third connecting portion 248 and the fourth connecting portion 250. In some implementations, the first line segment 252 is longer than the second line segment 254. In other implementations, the first line segment 252 is shorter than the second line segment 254. In several implementations, the first line segment 252 has a length that is similar to the second line segment 254.

In FIG. 2, a first center point 240 is located at a midpoint of the second line segment 254 (e.g., between the third connecting portion 248 and fourth connecting portion 250) and a second center point 242 is located at a midpoint of the first line segment 252 (e.g., between the first connecting portion 244 and second connecting portion 246). In some implementations, the Z-axis may pass through the first center point 240 and the second center point 242 may angularly offset about the X-axis. In other implementations, the Z-axis may pass through the second center point 242 and the first center point 240 may angularly offset about the X-axis. In some implementations, the third face 207 may form a concave curvature. In other implementations, the first face 206, second face 208 and third face 207 may be substantially or approximately flat relative to the XZ plane.

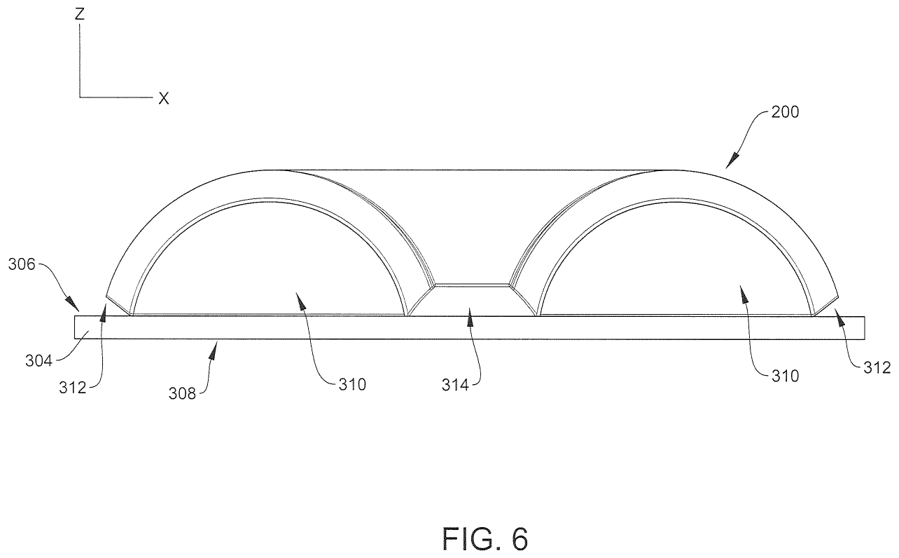

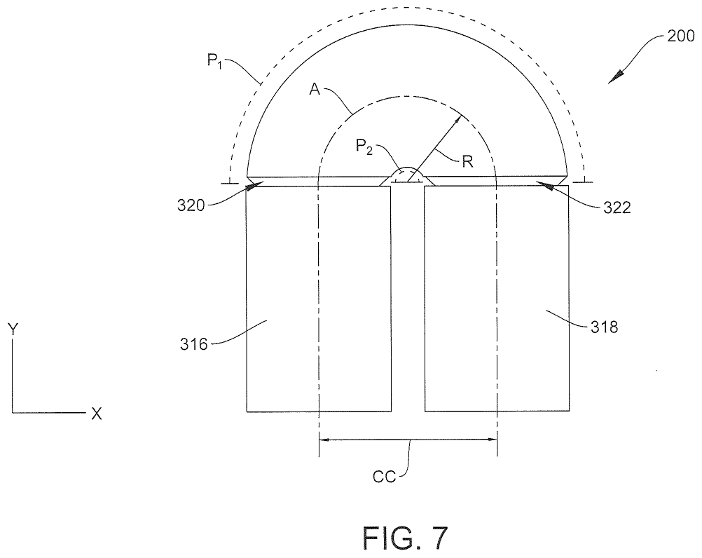

The first mounting end 202 and the second mounting end 204 are illustratively configured to mount or couple the half pipe return 200 to, for example, a mounting plate 304 as shown in FIG. 6. It will be appreciated that the half pipe return 200 may also be mounted directly to a piece of equipment such as, for example, a wall of a furnace 180. In FIG. 6, the half pipe return 200 is shown mounted or coupled to a pipe-mounting face 306 of the mounting plate 304 to form an illustrative cooling element. Referring to FIG. 7, the half pipe return 200 may include a first mounting end 202 having a first perimeter, P₁, which may be selected based on the desired heat transfer characteristics and space available for the return 200. The half pipe return 200 may include a second mounting end 204 having a second perimeter, P₂, which may be selected based on the desired heat transfer characteristics and space available for the return 200. The first perimeter P₁ may be greater than the second perimeter P₂. Opposite the pipe-mounting face 306 of the mounting plate 304 is an equipment-mounting face 308, which illustratively is configured to mount the plate 304 to a piece of equipment such as a wall of the furnace 180.

The half pipe return 200 may be mounted or coupled to the plate 304 in any suitable manner including, for example, by welding along the first mounting end perimeter P₁ of the first mounting end 202 and along the second mounting end perimeter P₂ of the second mounting end 204. For instance, as shown in FIG. 6, the half pipe return 200 may be mounted via a first weld 312 along P₁ of the first mounting end 202 and a second weld 314 along P₂ of the second mounting end 204 thereof. Each of the first and second welds 312, 314 may be fluid-tight welds to protect the integrity of the half pipe return 200 and prevent leakage of fluid that may flow through an interior passageway or channel 310 of the half pipe return 200. While it is shown that the half pipe return is coupled or mounted to the plate 304 via welding, it is to be appreciated that other forms of coupling or attaching the cooling element to the plate 304 may be implemented. Depending upon the application and environment, the cooling element may be coupled mechanically via a fastener, adhesive, or any other known way besides welding

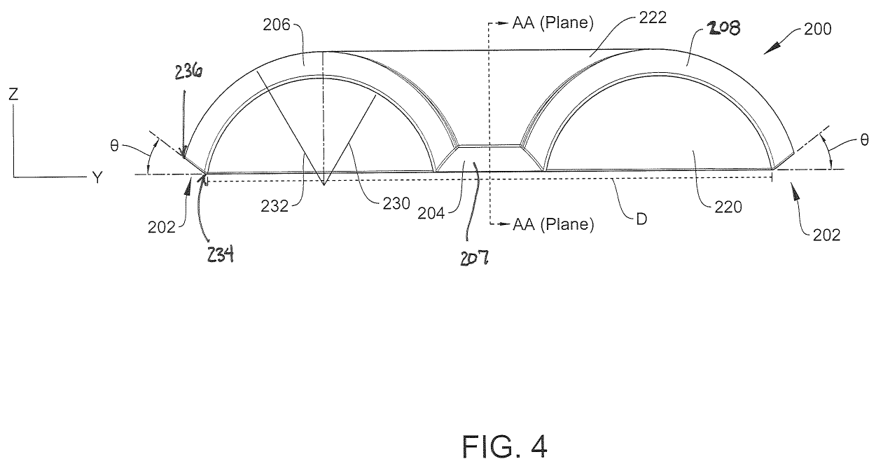

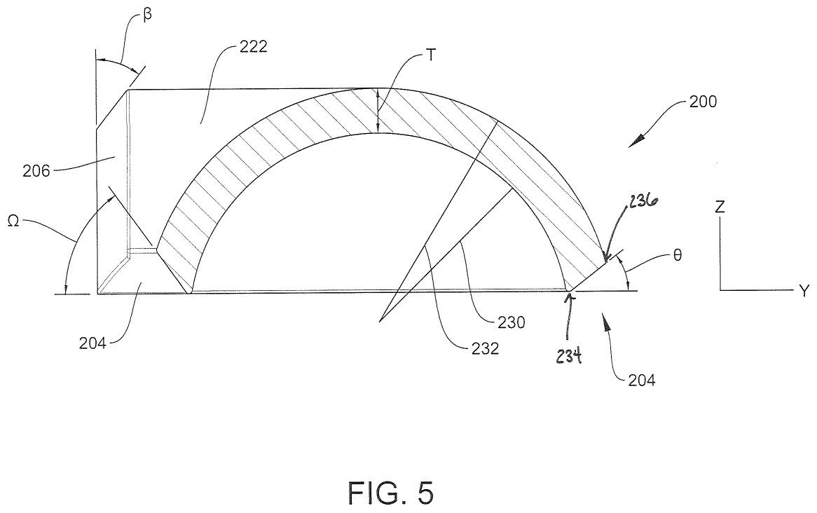

In FIG. 5 the illustrated half pipe return 200 is shown in a cross-sectional view about a plane AA (as shown in FIG. 4). The first mounting end 202 may be angled with respect to the bisected plane (i.e., the XY-plane) or plate 304. More specifically, a first end 234 of the first mounting end 202 is aligned along an X-axis whereas a second end 236 of the first mounting end 202 is angled with respect to the bisected XY-plane or mounting surface 306 of the mounting plate 304. In one instance, the first mounting end 202 may be angled relative to the XY-plane at an angle Θ, where Θ is greater than 0°. In one non-limiting example, angle Θ may be greater than 0° but less than 90°. In a second non-limiting example, angle Θ may be greater than 0° and less than 75°. In a third non-limiting example, angle Θ may be greater than 0° and less than 60°. In a fourth non-limiting example, angle Θ may be greater than 0° and less than 45°. In a fifth non-limiting example, angle Θ may be greater than 15° and less than 45°. In a sixth non-limiting example, angle Θ may be greater than 30° and less than 45°. In a further non-limiting example, angle Θ may be approximately between 30-40°.

The second mounting end 204 may be angled with respect to the bisected plane (i.e., the XY-plane) or mounting surface 306 of the mounting plate 304. More specifically, a second end surface of the second mounting end 204 may be angled with respect to the bisected plane or plate 304. In one instance, the second mounting end 204 is disposed at an angle Ω relative to the XY-plane, where Ω is greater than 0°. In one non-limiting example, angle Ω may be greater than 0° but less than 90°. In a second non-limiting example, angle Ω may be greater than 0° and less than 75°. In a third non-limiting example, angle Ω may be greater than 0° and less than 60°. In a fourth non-limiting example, angle Ω may be greater than 15° and less than 60°. In a fifth non-limiting example, angle Ω may be greater than 30° and less than 60°. In a sixth non-limiting example, angle Ω may be greater than 45° and less than 60°. In a further non-limiting example, angle Ω may be approximately between 50-60°.

Due to the angled first mounting end 202, the first mounting end 202 may contact the pipe-mounting surface 306 of the mounting plate 304 or wall of the furnace at a single point of its end, such as illustrated in the cross-sectional view of FIG. 6. The first mounting end 202 may contact the surface at this point along the entire first perimeter P₁ of the first mounting end 202.

Similarly, due to the angled second mounting end 204, the second mounting end 204 may contact the pipe-mounting surface 306 of the mounting plate 304 or wall of the furnace at a single point of its end, as is illustrated in the cross-sectional view of FIG. 5. The second mounting end 204 may contact the surface at this point along the entire second perimeter P₂ of the second mounting end 204.

With the first and second mounting ends 202 204 being angled, the first weld 312 and second weld 314 are capable of being disposed between the pipe-mounting surface 306 of the plate 304 or wall and at least a portion of a bottom surface of the respective first and second mounting ends 202, 204, respectively. This further enables a water-tight seal therebetween to prevent or inhibit leakage of a cooling fluid that is flowing through the cooling element or half pipe return 200. Moreover, the respective first and second mounting ends 202, 204 are more securely held to the mounting surface (e.g., mounting surface 306) with the weld being stronger than if the bottom surface of the mounting end was located flush with the pipe-mounting surface 306.

The conduit or channel 310 may extend from the first face 206 to the second face 208. The first and second faces 206, 208 may be angled on the outer surface 222. In one instance, the first and second faces 206, 208 form an angle β as shown in FIG. 5, where angle β is greater than 0°. In one non-limiting example, angle β may be greater than 0° but less than 90°. In a second non-limiting example, angle β may be greater than 0° and less than 75°. In a third non-limiting example, angle β may be greater than 0° and less than 60°. In a fourth non-limiting example, angle β may be greater than 0° and less than 45°. In a fifth non-limiting example, angle β may be greater than 15° and less than 45°. In a sixth non-limiting example, angle β may be greater than 30° and less than 45°. In a further non-limiting example, angle β may be approximately between 30-40°.

As shown in FIG. 7, the angled first and second faces 206, 208 allow for the half pipe return 200 to be connected to a first member 316 and a second member 318. The first and second members 316 318 may be in the form of a half pipe. Due to the first and second faces 206, 208 being angled, the cooling element may respectively contact the first and second members 316, 318 at a single point of the face.

The first and second members 316, 318 may be coupled to the half pipe return 200, for example, by welding. With the first and second faces 206, 208 being angled, a third weld 320 and a fourth weld 322 are capable of being disposed between the respective first and second members 316, 318 and the respective first and second faces 206, 208. This further enables a water-tight seal therebetween to prevent or inhibit leakage of a cooling fluid that is flowing through the cooling element. While it is shown that the members 316, 318 are coupled or mounted to the half pipe return via welding, it is to be appreciated that other forms of coupling or attaching the members 316, 318 to the return 200 may be implemented. Depending upon the application and environment, the cooling element 200 may be coupled mechanically via a fastener, adhesive, or any other known way besides welding.

When a single half pipe return 200 and plate 304 are coupled together, the conduit or channel 310 is formed therebetween and is configured to contain therein and allow the passage therethrough of a fluid including, without limitation, any suitable coolant such as, for example, a liquid. One non-exclusive example of a suitable liquid is water. The conduit or channel 310 may also be formed by directly mounting together a half pipe return 200 and a piece of equipment. The channel 310 may form a single fluid conduit between the first face 206 and the second face 208. It will also be appreciated that the conduit or channel 310 may be formed by forming a closed pipe having a generally flat surface extending between the first mounting end 202 and the second mounting end 204 along a bisecting plane. Such an illustrative surface, which need not be flat or planar, may be mounted together with either a plate or directly with a piece of equipment.

In some implementations, the inner surface 220 between the first and second mounting ends 202, 204 which extend from the first face 206 to the second face 208 may at least partially define the conduit or channel 310. In some implementations, the inner surface 220 and the pipe-mounting surface 306 or piece of equipment may at least partially define the conduit or channel 310.

The outer surface 222 may be generally smooth or incorporate geometries as required for a particular application such as, for example, any slag retention devices including ridges, splines, heat sinks, or any indentations. The half pipe return 200 as shown in FIG. 2 may have advantages over mitered pieces. Some of these advantages include less welds and creating a better flow for the cooling fluid to flow through the channel or conduit 310 as the cooling fluid would experience less frictional forces compared to the sharp nature of mitered returns. In other words, the design of the half pipe return 200 does not include any sharp angles or bends (e.g., 90° bend) so that the flow of fluid therethrough is able to flow uninterrupted and smoothly.

The half pipe return 200 may include several dimensions including, without limitation, a first mounting end diameter D representing the length of the bisecting plane extending between a contact point of the first mounting end 202, the inner surface 220, and the first face 206 and a second contact point of the first mounting end 202, the inner surface 220, and the second face 208. These dimensions may be selected as desired.

As shown in FIG. 7, the half pipe return 200 may include a center radius R extending from a point to an arc A on the bisecting plane. In one example, radius R may be constant along arc A between the first and second faces 206, 208. As a result, a center-to-center length, CC, is equal to two times the radius R. In another example, radius R may vary along arc A between the first and second faces 206, 208. In some implementations, the first mounting end 202 and the second mounting end 204 may be equidistance from arc A. In other implementations, the first and second mounting ends 202, 204 may not be equidistant from arc A. These dimensions may be selected as desired. In some implementations, the first and second mounting ends 202, 204 may be coaxial with one another. In a further implementation, the first and second mounting ends 202, 204 may be concentric with one another.

An inner radius 230 may be defined as the distance between a point along arc A and a point on the inner surface 220 where the point along arc A and the point on the inner surface 220 lie in a plane orthogonal to the XY plane. An outer radius 232 may be defined as the distance between a point along arc A and a point on the outer surface 222 where the point along arc A and the point on the inner surface 220 lie in a plane orthogonal to the XY plane.

A thickness T may be defined as the difference between the inner and outer radii 230, 232 or surfaces 220, 222. In one example, the thickness T of each portion may be uniform. In another example, the thickness T may vary from one end to an opposite end. In a further example, the thickness T may vary from the first face 206 to the second face 208.

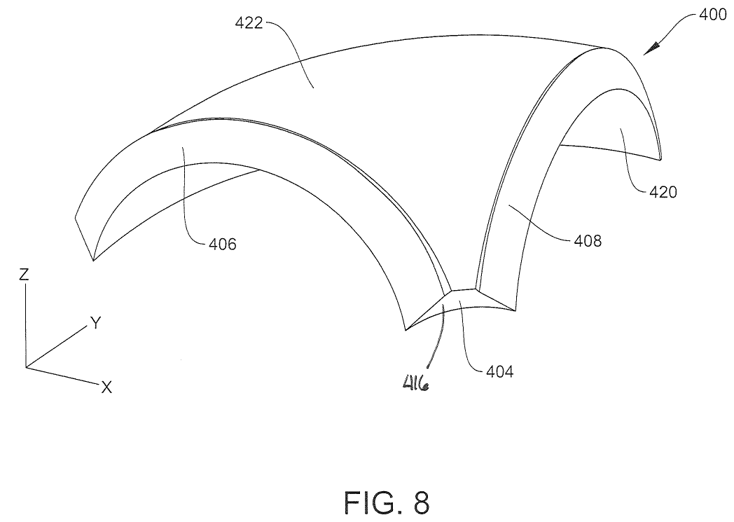

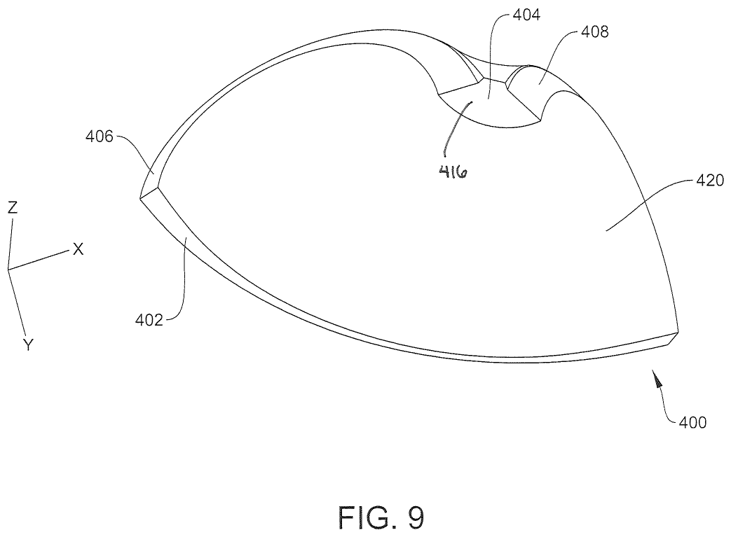

Referring now to FIG. 8, another implementation of a cooling element in the form of a half pipe return or elbow 400 is shown. Here, the cooling element 400 depicted in the form of a half pipe elbow 400 is formed into a desired shape. The desired shape may be, for example, a bent half pipe having a cross-section approximating a substantially bisected circle or polygon such as a quadrilateral, a parallelogram, a hexagon or an octagon in cross-section. In other words, the half pipe elbow 400 illustratively may approximate a bent or angled polyhedron or bent or angled cylinder substantially bisected along a plane of a diameter thereof to form a bent or angled semi-polyhedron or the depicted illustrative bent or angled semi-cylindrical body as described below. As shown in FIGS. 8 and 9, the illustrated half pipe elbow 400 extends from a first mounting end 402 to a second mounting end 404 to define an arcuate and generally concave inner surface 420 and an arcuate and generally convex outer surface 422 arcing respectively between the first mounting end 402 and the second mounting end 404. The first mounting end 402 may be spaced from the second mounting end 404. The half pipe elbow 400 may have a first face 406 and a second face 408 formed between the first mounting end 402 and the second mounting end 404. The first face 406 is spaced apart from the second face 408 and may be angled substantially perpendicular to one another. In other words, the half pipe elbow 400 represents a segmented portion of a hollow torus or donut shape in the form of a hollow ring torus divided in a first plane, a second plane, and a third plane. For example, the half pipe elbow 400 may take the form of a hollow ring torus divided in an XY-plane, an XZ-plane, and a YZ-plane.

The half pipe elbow 400 may include a third face 416 formed at or by the second mounting end 404. The third face 416, like the third face 207 of FIG. 2, is located between the first face 406 and second face 408. In at least one implementations, one or more of the characteristics of the third face 207 described above may the same for the third face 416 of FIG. 8. For example, the third face 416 may have an area that is less than the first face 406 and second face 408. In some implementations, the first face 406 and second face 408 (like the first face 206 and second face 208 of FIG. 2) may have similar areas. In several implementations, a portion of the third face 416 that is congruent with the outer surface 422 is smaller (or has a smaller radius) than another portion of the third face 416 that is congruent with the inner surface 420.

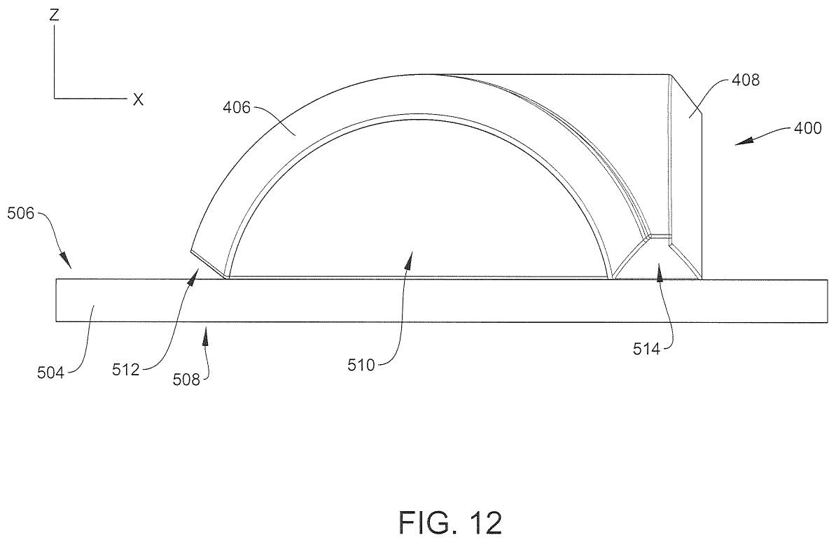

The first mounting end 402 and the second mounting end 404 are illustratively configured to mount or couple the half pipe elbow 400 to, for example, a mounting plate 504 as shown in FIG. 12. It will be appreciated that the half pipe elbow 400 may be alternatively mounted directly to a piece of equipment such as, for example, a wall of a furnace. In FIG. 12, the half pipe elbow 400 is shown mounted or coupled to a pipe-mounting face 506 of the mounting plate 504 to form an illustrative cooling element. The half pipe elbow 400 may include a first perimeter, P₃, at the first mounting end 402 which may be selected based on the desired heat transfer characteristics and space available for the elbow 400. The half pipe elbow 400 may include a second perimeter, P₄, at the second mounting end 404 which may be selected based on the desired heat transfer characteristics and space available for the elbow 400. The first mounting end perimeter P₃ may be greater than the second mounting end perimeter P₄. Opposite the pipe-mounting face 506 of the mounting plate 504 is an equipment-mounting face 508, which is configured to mount the plate 504 to a piece of equipment.

The half pipe elbow 400 may be mounted or coupled to the plate 504 in any suitable manner including, for example, by welding along the first perimeter P₃ of the first mounting end 402 and along the second perimeter P₄ of the second mounting end 404. For instance, as shown in FIG. 12, the half pipe elbow 400 may be mounted via a first weld 512 along P₃ of the first mounting end 402 and a second weld 414 along P₄ of the second mounting end 404 thereof. Each of the first and second welds 412, 414 may be fluid tight welds to protect the integrity of half pipe elbow 400 and prevent leakage of fluid that may flow through an interior passageway or channel 510 of the half pipe elbow 400. While it is shown that the half pipe elbow is coupled or mounted to the plate 504 via welding, it is to be appreciated that other forms of coupling or attaching the cooling element to the plate 504 may be implemented. Depending upon the application and environment, the cooling element may be coupled mechanically via a fastener, adhesive, or any other known way besides welding

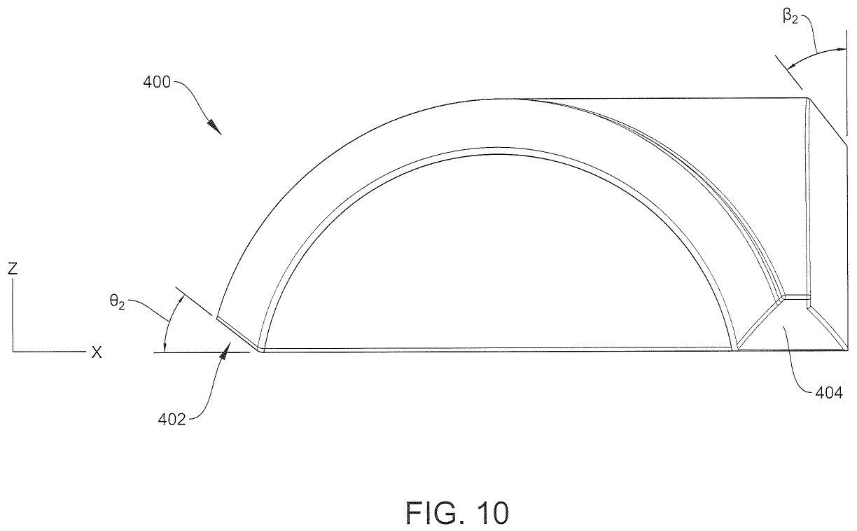

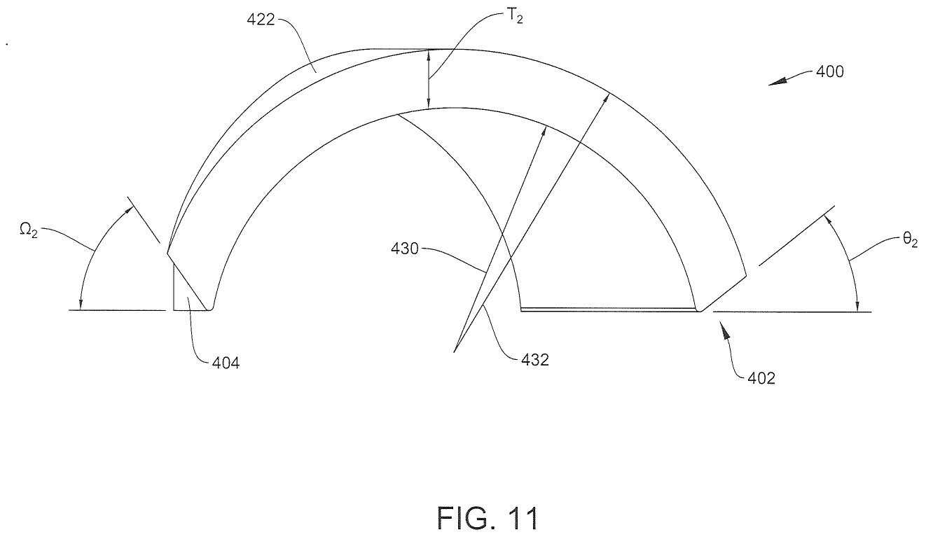

As shown in FIGS. 10-12, the first mounting end 402 may be angled with respect to the bisected plane (i.e., the XY-plane) or plate 504 in the same way as the first mounting end 202 of FIG. 2. More specifically, a first end (e.g., end 234) of the first mounting end 402 is aligned along an X-axis whereas a second end (e.g., end 236) of the first mounting end 402 is angled with respect to the bisected XY-plane or mounting surface of the mounting plate 504. In one instance, the first mounting end 402 may be angled relative to the XY-plane at an angle Θ₂, where Θ₂ is greater than 0°. In one non-limiting example, angle Θ₂ may be greater than 0° but less than 90°. In a second non-limiting example, angle Θ may be greater than 0° and less than 75°. In a third non-limiting example, angle Θ₂ may be greater than 0° and less than 60°. In a fourth non-limiting example, angle Θ₂ may be greater than 0° and less than 45°. In a fifth non-limiting example, angle Θ₂ may be greater than 15° and less than 45°. In a sixth non-limiting example, angle Θ₂ may be greater than 30° and less than 45°. In a further non-limiting example, angle Θ₂ may be approximately between 30-40°, where approximately is defined in this disclosure as being within 2-3°.

The second mounting end 404 may be angled with respect to the bisected plane (i.e., the XY-plane) or plate 504. More specifically, a second end surface of the second mounting end 404 may be angled with respect to the bisected plane or plate 504. In one instance, the second mounting end 404 may comprise an angle Ω₂, where Ω₂ is greater than 0°. In one non-limiting example, angle Ω₂ may be greater than 0° but less than 90°. In a second non-limiting example, angle Ω₂ may be greater than 0° and less than 75°. In a third non-limiting example, angle Ω₂ may be greater than 0° and less than 60°. In a fourth non-limiting example, angle Ω₂ may be greater than 15° and less than 60°. In a fifth non-limiting example, angle Ω₂ may be greater than 30° and less than 60°. In a sixth non-limiting example, angle Ω₂ may be greater than 45° and less than 60°. In a further non-limiting example, angle Ω₂ may be approximately between 50-60°, where approximately is defined herein as being within 2-3°.

Due to the angled first mounting end 402, the first mounting end 402 may contact the pipe-mounting surface of the mounting plate 504 or wall of the furnace at a single point of its end, as illustrated in the cross-sectional view of FIG. 12. The first mounting end 402 may contact the surface at this point along the entire first perimeter P₃ of the first mounting end 402.

Similarly, due to the angled second mounting end 404, the second mounting end 404 may contact the pipe-mounting surface of the mounting plate 504 or wall of the furnace at a single point of its end, as illustrated in the cross-sectional view of FIG. 12. The second mounting end 404 may contact the surface at this point along the entire second perimeter P₄ of the second mounting end 404.

With the first and second mounting ends 402, 404 being angled, the first weld 512 and second weld 414 are capable of being disposed between the pipe-mounting surface of the plate 504 or wall and at least a portion of a bottom surface of the respective first and second mounting ends 402, 404. This further enables a water-tight seal therebetween to prevent or inhibit leakage of a cooling fluid that is flowing through the cooling element or half pipe elbow 400. Moreover, the respective first and second mounting ends 402, 404 are more securely held to the mounting surface with the weld being stronger than if the bottom surface of the mounting end was located flush with the pipe-mounting surface.

The conduit or channel 510 may extend from the first face 406 to the second face 408. The first and second faces 406, 408 may be angled on the outer surface 422. In one instance, the first and second faces 406, 408 include an angle β₂, where angle β₂ is greater than 0°. In one non-limiting example, angle β₂ may be greater than 0° but less than 90°. In a second non-limiting example, angle β₂ may be greater than 0° and less than 75°. In a third non-limiting example, angle β₂ may be greater than 0° and less than 60°. In a fourth non-limiting example, angle β₂ may be greater than 0° and less than 45°. In a fifth non-limiting example, angle β₂ may be greater than 15° and less than 45°. In a sixth non-limiting example, angle β₂ may be greater than 30° and less than 45°. In a further non-limiting example, angle β₂ may be approximately between 30-40°, where approximately is defined herein as being within 2-3°.

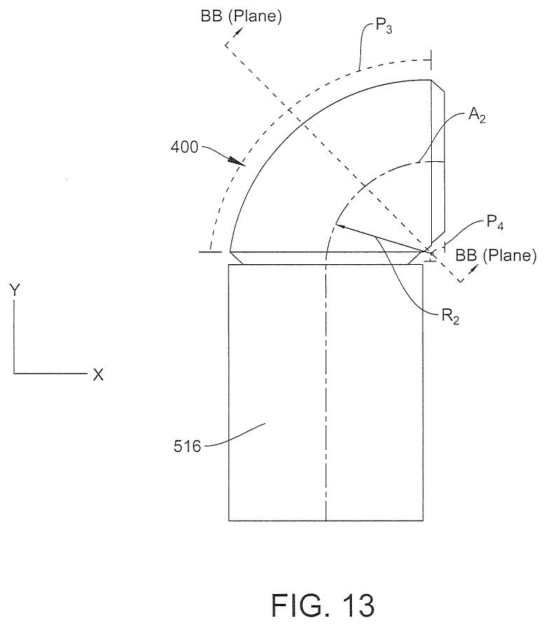

As shown in FIG. 13, the angled first or second faces 406, 408 allow for the half pipe elbow 400 to be connected to a first member 516. The first member 516 may be in the form of a half pipe 400 or other piping 150. Due to the first and second faces 406, 408 being angled, the cooling element 400 may respectively contact the first member 516 at a single point of the face. Although illustrated that the first member 516 is coupled to the first face 406, it should be understood that the first member 516 or an additional member may be coupled to the second face 408, alternatively or additionally.

The first member 516 may be coupled to half pipe elbow 400, for example, by welding along the first or second face 406, 408 when the first member 516 is adjacent the half pipe elbow 400. While it is shown that the member 516 is coupled or mounted to the half pipe elbow 400 via welding, it is to be appreciated that other forms of coupling or attaching the member 516 to the elbow 400 may be implemented. Depending upon the application and environment, the cooling element 400 may be coupled mechanically via a fastener, adhesive, or any other known way besides welding.

When a single half pipe elbow 400 and plate 504 are coupled together, the conduit or channel 510 is formed and configured to contain therein and allow the passage therethrough of a fluid including, without limitation, any suitable coolant such as, for example, a liquid. One non-exclusive example of a suitable liquid is water. The conduit or channel 510 may also be formed by directly mounting together a half pipe elbow 400 and a piece of equipment. It will also be appreciated that the conduit or channel 510 may be formed by forming a closed pipe having a generally flat surface extending between the first mounting end 402 and the second mounting end 404 along a bisecting plane. Such an illustrative surface, which need not be flat or planar, may be mounted together with either a plate or directly with a piece of equipment.

In some implementations, the inner surface 420 between the first and second mounting ends 402, 404 which extend from the first face 406 to the second face 408 may at least partially define the conduit or channel 510. In some implementations, the inner surface 420 and the pipe-mounting surface or piece of equipment may at least partially define the conduit or channel 510.

The half pipe elbow 400 may include several dimensions including, without limitation, a first mounting end 402 diameter representing the length of the bisecting plane extending between a contact point of the first mounting end 402, the inner surface 420, and the first face 406 and a second contact point of the first mounting end 402, the inner surface 420, and the second face 408. These dimensions may be selected as desired.

As shown in FIG. 13, the half pipe elbow 400 may include a center radius R₂ extending from a point to an arc A₂ on the bisecting plane. In one example, radius R₂ may be constant along arc A₂ defined between the first and second faces 406, 408. In another example, radius R₂ may vary along arc A₂ between the first and second faces 406, 408. In some implementations, the first mounting end 402 and the second mounting end 404 may be equidistant from arc A₂. In other implementations, the first mounting end 402 and the second mounting end 404 may not be equidistant from arc A₂. These dimensions may be selected as desired.

In some implementations, the first and second mounting ends 402, 404 may be coaxial with one another. In a further implementation, the first and second mounting ends 402, 404 may be concentric with one another.

A first inner radius 430 may be defined as the distance between a point along arc A₂ and a point on the inner surface 420 where the first inner radius 430 is orthogonal to the bisected plane (i.e., the XY plane) or the plate 504. A second inner radius 432 may be defined as the distance between a point along arc A₂ and a point on the outer surface 422 where the second inner radius 432 is orthogonal to the bisected plane (i.e., the XY plane) or the plate 504.

The outer surface 422 may be generally smooth or incorporate geometries as required for a particular application such as, for example, any slag retention devices including ridges, splines, heat sinks, or any indentations. The half pipe elbow 400 as shown in FIG. 8 may have advantages over mitered pieces. Some of these advantages include less welding and a better flow for the cooling fluid to flow through the conduit or channel 510 as the cooling fluid would experience less frictional forces compared to the sharp nature of mitered return elbows.

A thickness T₂ may be defined as the difference between the first and second radii 430, 432 or surfaces 420, 422. In one example, the thickness T₂ may be uniform between the first mounting end 402 and the second mounting end 404. In another example, the thickness T₂ may vary between the first mounting end 402 and the second mounting end 404. In a further example, the thickness T₂ may vary from the first face 406 to the second face 408.

The material selections for the half pipe return 200 or elbow 400 may be selected from a wider range of flat or shaped materials, which may be stamped, formed, cast, or forged into the desired semi-circular cross section or semi-cylindrical shape, which improves the operability of the cooling element relative to the prior art circular tube and cooling elements formed therefrom. The higher heat transfer of the present disclosure may have the effect of improving equipment longevity plus on-line reliability and up-time because the equipment will be better suited to resist the effects of the high heat flux, corrosive and abrasive atmosphere in the furnace, flue gas system or combustion chamber, and any other equipment protected by one or more assembly(s) of such element(s).

The material may be selectively fabricated from any suitable material including, for example, steel (e.g., stainless steel, cast steel, extruded steel and drawn steel), iron (e.g., cast iron), nickel (e.g., nickel alloy), copper, bronze, as well as any other suitable element, composite or alloy including, for example, aluminum-bronze alloys.

While the disclosure has been illustrated and described in detail in the foregoing drawings and description, the same is to be considered as illustrative and not restrictive in character, it being understood that only illustrative implementations thereof have been shown and described and that all changes and modifications that come within the spirit of the disclosure are desired to be protected.

1. A cooling assembly for cooling exhaust gases emitted from a steel-making furnace comprising:
a body configured to be coupled to a surface of the furnace, the body comprising a cross-sectional shape having a thickness defined between an outer surface and an inner surface thereof, the body including a first mounting end having a first length and a second mounting end having a second length, the second length being different from the first length;
wherein, the body is arcuately-shaped with a concave inner surface and convex outer surface;
wherein, the second mounting end is spaced from the first mounting end;
wherein, a fluid conduit is defined between the inner surface and the surface for a cooling fluid to flow therethrough.

2. The cooling assembly of claim 1, wherein the first mounting end and the second mounting end comprise a curvature shape.

3. The cooling assembly of claim 1, wherein the body forms a first face and a second face, the first face located at the first mounting end and the second face located at the second mounting end.

4. The cooling assembly of claim 3, wherein the first and second faces are parallel to one another.

5. The cooling assembly of claim 3, wherein the first face and the second face are disposed at an angle relative to a vertical plane passing through the first and second mounting ends.

6. The cooling assembly of claim 3, wherein the first face is offset from the inner surface.

7. The cooling assembly of claim 3, wherein the second face is offset from the inner surface.

8. The cooling assembly of claim 3, wherein the inner surface comprises a radial inner surface.

9. The cooling assembly of claim 3, wherein:
the first face forms a first outer portion that is configured to be in contact with the surface, the first outer portion being disposed at angle relative to a horizontal plane formed by the surface;
the second face forms a second outer portion that is configured to be in contact with the surface, the second outer portion being disposed at angle relative to the horizontal plane.

10. The cooling assembly of claim 3, wherein the first face and the second face are located approximately 180° relative to one another about an axis passing through the inner surface.

11. The cooling assembly of claim 3, wherein the first face and the second face are located less than 180° relative to one another about an axis passing through the inner surface.

12. The cooling assembly of claim 1, wherein the inner surface forms a first circumference and the outer surface forms a second circumference, the first circumference being less than the second circumference.

13. A heat exchange system, comprising:
a furnace configured to heat an interior of the furnace and generate hot exhaust gases;
a panel of sinuously winding piping having an inlet and an outlet, the piping forming a fluid passage through which a cooling fluid flows between the inlet and the outlet;
the piping comprising a body configured to be coupled to a mounting surface of the furnace, the body comprising a cross-sectional shape having a thickness defined between an outer surface and an inner surface thereof, the body including a first mounting end having a first length and a second mounting end having a second length, the second length being different from the first length;
wherein, the body is arcuately-shaped with a concave inner surface and convex outer surface;
wherein, the second mounting end is spaced from the first mounting end.

14. The heat exchange system of claim 13, wherein the body forms a first face and a second face, the first face located at the first mounting end and the second face located at the second mounting end.

15. The heat exchange system of claim 13, wherein the first face and the second face are disposed at an angle relative to a vertical plane passing through the first and second mounting ends.

16. The heat exchange system of claim 13, wherein the first face and the second face are offset from the inner surface.

17. The heat exchange system of claim 13, wherein:
the first face forms a first outer portion that is configured to be in contact with the surface, the first outer portion being disposed at angle relative to a horizontal plane formed by the surface;
the second face forms a second outer portion that is configured to be in contact with the surface, the second outer portion being disposed at angle relative to the horizontal plane.

18. The heat exchange system of claim 13, wherein the first face and the second face are located approximately 180° relative to one another about an axis passing through the inner surface.

19. The heat exchange system of claim 13, wherein the first face and the second face are located less than 180° relative to one another about an axis passing through the inner surface.

20. A cooling assembly for cooling exhaust gases emitted from a steel-making furnace, comprising:
a plate configured to be coupled to the furnace, the plate having a first surface and a second surface, the first surface opposite the second surface;
a body coupled to the plate, the body comprising
an inner surface;
an outer surface;
a first mounting end having a first length and extending from a first face to a second face,
a second mounting end having a second length and extending from the first face to the second face, the second length different from the first length;
wherein the first mounting end is mounted to the first surface at a first angle greater than 0°;
wherein the second mounting end is mounted to the first surface at a second angle greater than 0°, the first mounting end spaced from the second mounting end;
wherein a fluid conduit is formed between the inner surface and the first surface.
